(19) United States
(12) Patent Application Publication
(10) Pub. No.: US 2004/0077358 A1
(43) Pub. Date: Apr. 22, 2004

(54) Methods and systems for distributed arbitration in a push-to-talk communications system

(75) Inventors: Christopher John Bennett, San Diego, CA (US); Jeffrey Michael McDaniel, San Diego, CA (US)

Correspondence Address: JENKINS & WILSON, PA, 3100 TOWER BLVD, SUITE 1400, DURHAM, NC, 27707, US

(73) Assignee: Togabi Technologies

(21) Appl. No.: 10/273,482

(22) Filed: Oct. 18, 2002

(51) Int. Cl. H04B 1/44; H04Q 7/20

(52) U.S. Cl. 455/455; 455/78

(57) ABSTRACT

Methods and systems for distributed arbitration in a push-to-talk communications system are disclosed. A server receives talk requests from user communications terminals in a push-to-talk communications system. The server generates state information based on the talk requests and delivers the state information to the user communications terminals. The user communications terminals execute a distributed arbitration algorithm to determine which user communications terminal should have possession of a communications channel among user communications terminals with simultaneously pending talk requests based on the state information.

### TECHNICAL FIELD

The present invention relates to methods and systems for arbitration in a push-to-talk communications system. More particularly, the present invention relates to methods and systems for distributed arbitration in a push-to-talk communications system.

### BACKGROUND ART

A push-to-talk communications system is a system where groups of users can communicate with each other using user communications terminals, such as mobile telephone handsets or personal computers. In such systems, a user desiring to communicate with a group of users may depress a button on his/her user communications terminal to request communication with the group of users. Once the user is granted permission, the user speaks into his/her user communications terminal, and the user's voice is packetized and sent to other user communications terminals in the group. An arbitration mechanism is used to determine who gets to talk when multiple users request the floor at the same time.

In conventional push-to-talk communications systems, the arbitration function is centralized. For example, U.S. Pat. No. 6,360,093 describes a push-to-talk, Internet broadcast system in which arbitration is performed by a central server. Performing arbitration at a central server has a number of disadvantages. For example, if the arbitration function at the server fails, communications between the user communications terminals may be disabled. In addition, because a single server handles the arbitration for multiple users, the processing load on the server can result in delays in determining which user communications terminal controls the communication channel. Accordingly, there exists a need for improved methods and systems for arbitration in a push to-talk communications system.

### DISCLOSURE OF THE INVENTION

The present invention includes the methods and systems for distributed arbitration in a push-to-talk communications system. According to one aspect of the invention, a server receives talk requests from user communications terminals requesting possession of a communications channel in a push-to-talk communications system. The server generates state information based on the talk requests and distributes the state information to the user communications terminals. The user communications terminals execute a distributed arbitration algorithm to determine which user communications terminal should have possession of the communications channel among user communications terminals with simultaneously pending talk requests based on the state information. Because the arbitration algorithm is performed by the user communications terminals, rather than by the server, the processing load on the server is reduced over conventional server based arbitration mechanisms.

Accordingly, it is an object of the invention to provide methods and systems for distributed arbitration in a push-to-talk communications system.

Some of the objects of the invention having been stated hereinabove, other objects will become evident as the description proceeds when taken in connection with the accompanying drawings as best described hereinbelow.

### BRIEF DESCRIPTION OF THE DRAWINGS

Preferred embodiments of the invention will now be explained with reference the accompanying drawings of which:

FIG. 1 is a block diagram of a push-to-talk communications system including a distributed arbitration algorithm according to an embodiment of the present invention;

FIG. 2 is a flow chart illustrating exemplary steps that may be performed by a server in a push-to-talk communications system according to an embodiment of the present invention;

FIG. 3 is a flow chart illustrating exemplary steps that may be performed by a user communications terminal in arbitrating and taking possession of a communications channel in a push-to-talk communications system according to an embodiment of the present invention; and

FIG. 4 is a flow chart illustrating exemplary steps that may be performed by a server in response to an error condition in a push-to-talk communications system according to an embodiment of the present invention.

### DETAILED DESCRIPTION OF THE INVENTION

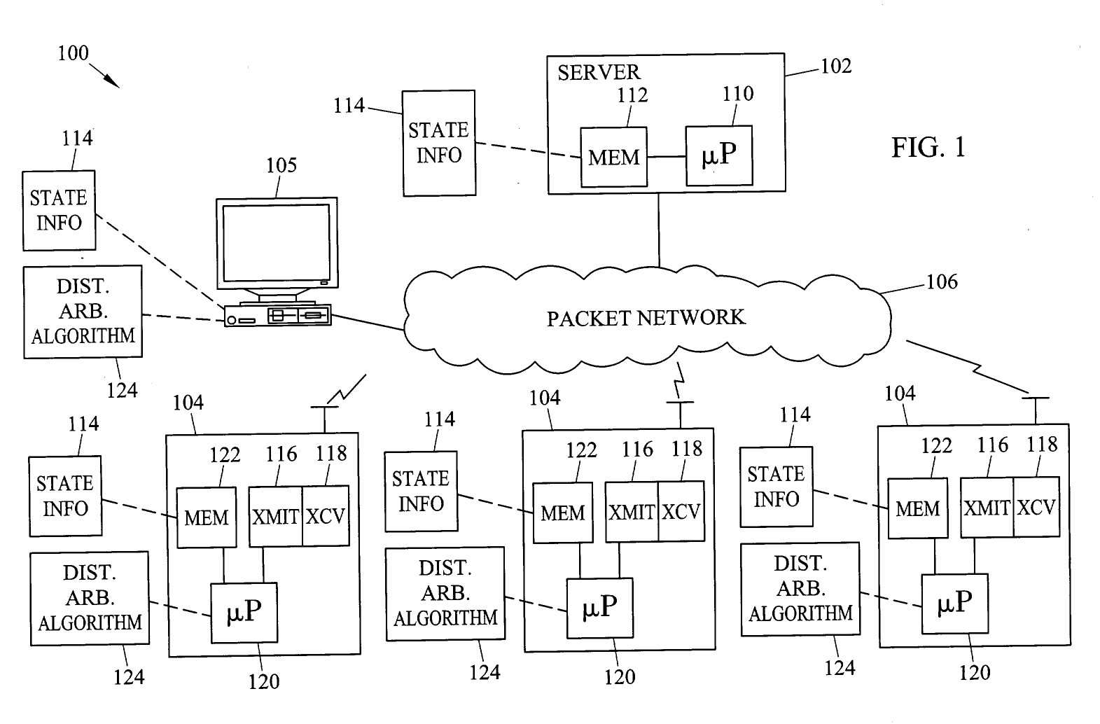

FIG. 1 is a block diagram illustrating a push-to-talk communication system including a distributed arbitration algorithm according to an embodiment of the present invention. Referring to FIG. 1, communications system 100 includes a server 102, a plurality of user communications terminals, including handsets 104 and general-purpose computer 105. Handsets 104 communicate with each other and with general-purpose computer 105 by sending packetized voice information to server 102 via packet network 106. Server 102 distributes the packetized voice information received from one user communications terminal to all user communications terminals desiring to communicate with each other.

In the illustrated embodiment, server 102 includes a microprocessor 110 and memory 112. Microprocessor 110 executes programs for generating state information 114 regarding the state of the system and for distributing the state information to user communications terminals 104 and 105.

In the illustrated example, handsets 104 each include transmitters 116 and receivers 118 for sending and receiving packetized voice and data over packet network 106. In addition, handsets 104 each include a microprocessor 120 and memory 122. Microprocessor 120 executes a distributed arbitration algorithm 124 for determining which user communications terminal should have possession of the communications channel based on state information 114 received from server 102. This distributed arbitration algorithm will be described in more detail below.

General-purpose computer 105 may be a desktop personal computer, a workstation, a handheld computer, a laptop computer, or any other suitable computing platform with network communications capabilities. General-purpose computer 105 may be connected to packet network 106 via a wireless or wireline link. In the illustrated embodiment, general-purpose computer 105 is connected to packet network 106 via a wireline link. Accordingly, it is understood that general-purpose computer 105 may include one or more network interface adapters and the appropriate communications protocol stack, such as a TCP/IP or UDP/IP stack.

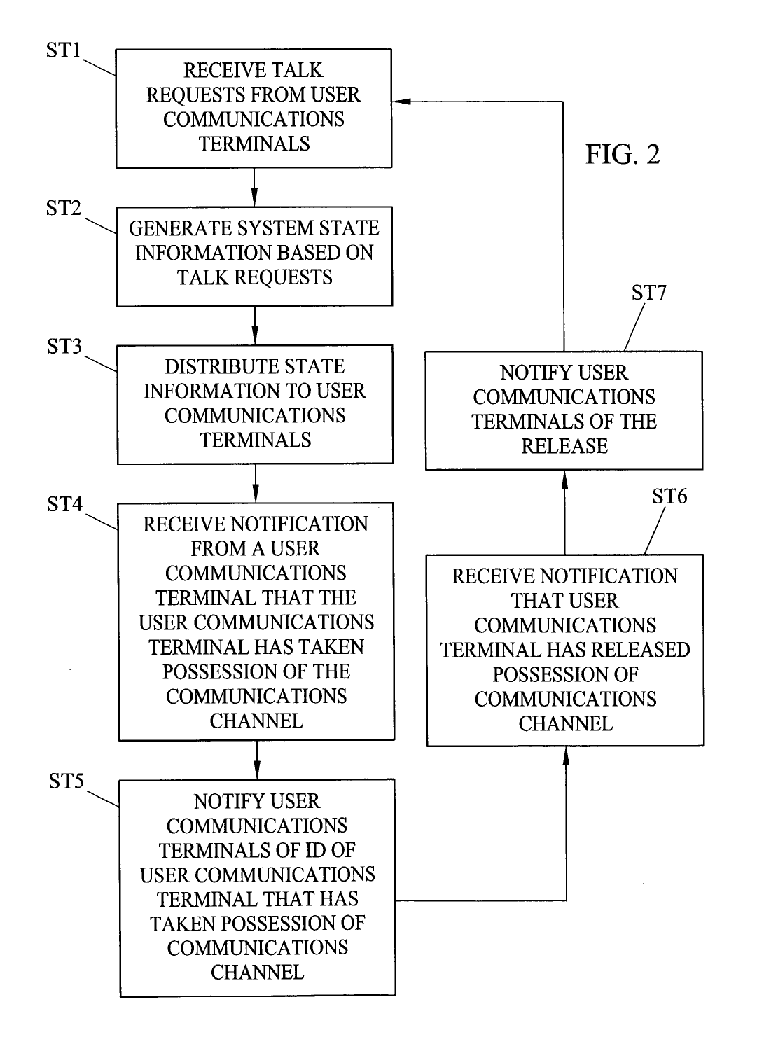

FIG. 2 is a flow chart illustrating exemplary steps that may be performed by server 102 illustrated in FIG. 1. Referring to FIG. 2, in step ST1, server 102 receives talk requests from user communications terminals 104 and 105. In the one example, the talk requests include the ID of the user communications terminal requesting the communications channel. In alternate embodiment, the talk requests may each include a priority level indicating a talk priority of the issuing user communications terminal in addition to the user communications terminal ID. In step ST2, the server generates system state information based on the talk requests. Generating system state information may include ordering the talk requests according to time of receipt of the talk requests. In step ST3, the server distributes the state information to the user communications terminals.

In step ST4, the server receives notification from a user communications terminal that the user communications terminal has taken possession of the communications channel. In step ST5, the server notifies the user communications terminals of the ID of the user communications terminal that has taken possession of the communications channel. In step ST6, the server receives notification that the user communications terminal has released possession of the communications channel, and in step ST7 notifies the user communications terminals of the release. The steps illustrated in FIG. 2 may be repeated continuously by the server while the communications channel is active.

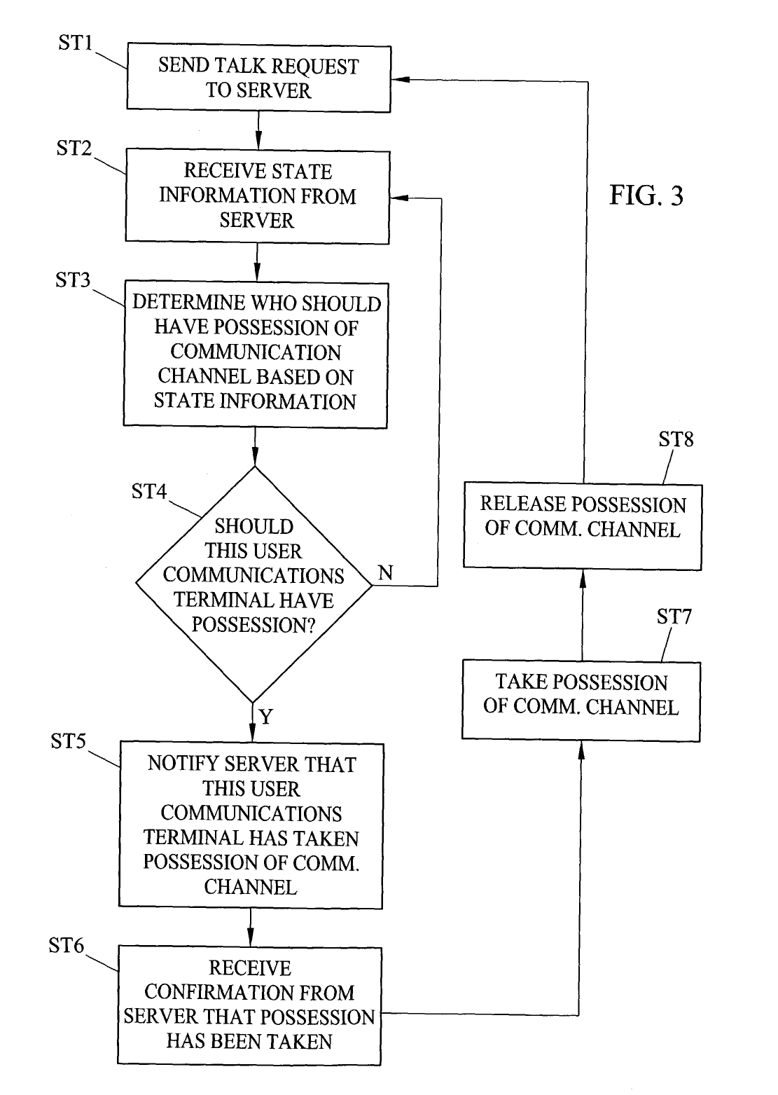

FIG. 3 illustrates exemplary steps that may be performed by a user communications terminal according to an embodiment of the present invention. Referring to FIG. 3, in step ST1, the user communications terminal sends a talk request to the server. In step ST2, the user communications terminal receives state information from the server. The state information may include a list of user communications terminal IDs that have currently pending talk requests with the server. The state information may also include priority levels of each user communications terminal with the pending talk request. In step ST3, distributed arbitration algorithm 124 on each user communications terminal determines who should have possession of the communications channel based on the state information. If no priority levels are implemented, this step may simply include determining which user communications terminal is at the head of the queue based on time of receipt of the talk requests at the server. In one exemplary embodiment, the server may update the state of the system each time a new talk request is received. The server may also distribute to the user communications terminals an indication of the user communications terminals' current positions in the queue. In this case, step ST3 may include determining whether the particular user communications terminal is at the head of the queue based on the position received from the server.

If priority levels are implemented, the server may distribute the IDs of the user communications terminals with pending talk requests and the corresponding priority levels to the user communications terminals. At each user communications terminal, the distributed arbitration algorithm may determine which user communications terminal should have possession of the communications channel based on the priority levels.

In step ST4, if the particular user communications terminal determines that it should have possession of the communications channel, control proceeds to step ST5 where the user communications terminal notifies the server that this user communications terminal has taken possession of the communications channel. In step ST6, the user communications terminal receives confirmation from the server that possession has been successfully taken. In step ST7, the user communications terminal takes possession of the communications channel. Once this occurs, the user of the user communications terminal can talk to the other user communications terminals via the communications channel. In step ST8, the user communications terminal releases possession of the communications channel. The steps illustrated in FIG. 3 may be performed each time a user communications terminal desires to take possession of the communications channel.

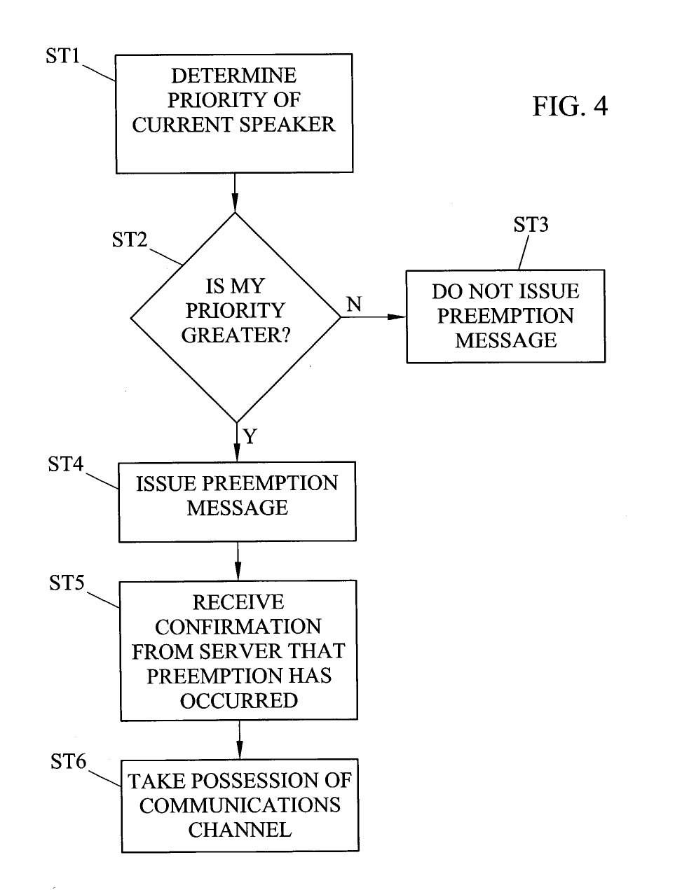

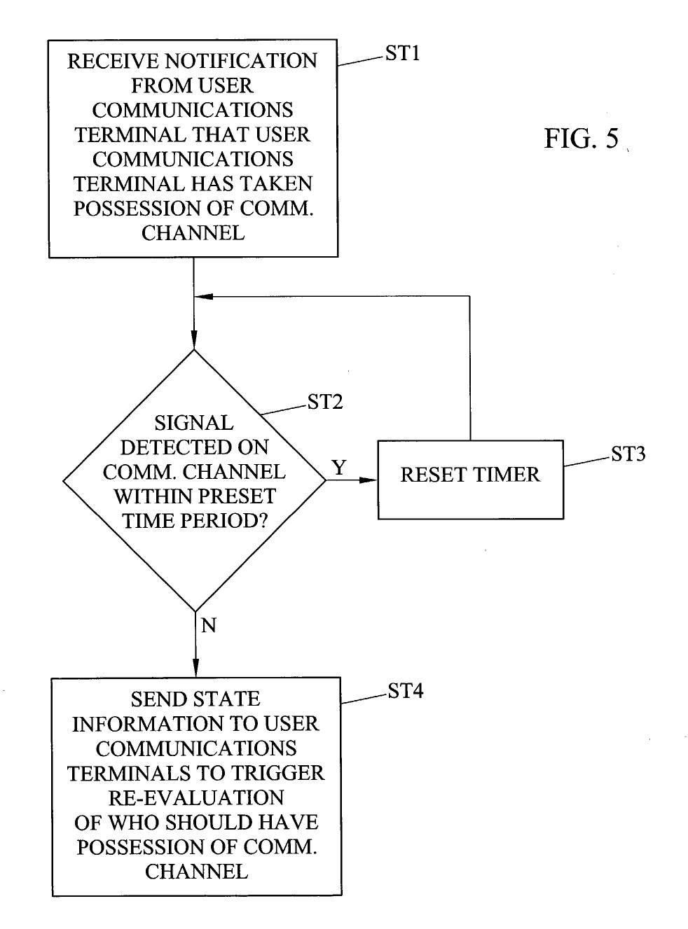

In some instances, the user of a particular user communications terminal may wish to preempt the speaker that currently has the floor. Accordingly, in one embodiment of the invention, a preemption priority scheme is implemented where one or more priorities are associated with the privilege of preemption. FIG. 4 illustrates exemplary steps that may be performed by a user communications terminal possessing a preemption priority in taking control of the communications channel from a user that currently has control of the communications channel. Referring to FIG. 4, in step ST1, the user communications terminal determines the priority of the speaker that currently has possession of the communications channel. In step ST2, the user communications terminal determines whether its priority is greater than that of the current speaker. If the priority is not greater, control proceeds to step ST3 where preemption processing ends.

However, if the user communications terminal determines that its priority is greater than that of the current speaker, control proceeds to step ST4 where the user communications terminal issues a preemption message. The preemption message notifies the server that the user communications terminal intends to take possession of the communications channel from a user communications terminal that currently has possession of the communication channel. The server may validate this instruction and send confirmation to the user communications terminal. In step ST5, the user communications terminal receives confirmation that preemption has occurred. In step ST6, the user communications terminal takes over the communications channel from the current speaker.

In some instances, error conditions may occur where a user communications terminal that should take possession of the communications channel fails to do so or fails to use communications channel resources within a predetermined time period. FIG. 5 illustrates exemplary steps that may be performed by server 102 in resolving this error condition. Referring to FIG. 5, in step ST1, the server receives notification from a user communications terminal that the user communications terminal is taking possession of the communications channel. In step ST2, the server determines whether a signal has been detected on the communications channel within a predetermined time period. If a signal has been detected, control proceeds to step ST3 where the server resets a communications channel timer. The communications channel timer may count up to a predetermined value indicative of a maximum amount of time that a user with possession of the communications channel should be allowed to hold the channel without talking over the channel. Once the predetermined value is reached, the server determines that the communications channel is not being used. The purpose of this timer is to prevent the communications channel from being reserved by a user communications terminal and then not used. In step ST4, if the server determines that the communications channel timer has expired, the server sends state information to the user communications terminals to trigger recalculation of who should have possession of the communications channel. This state information may include:

(1) a notification to all user communications terminals that the floor is open, causing the user communications terminals to reevaluate the state of the queue;

(2) a notification to all user communications terminals of the correct state of the queue notifying the user communications terminal that should have the floor to determine that it does have the floor; or

(3) a reset message indicating to the user communications terminals to discharge the current system state information. The user communications terminals will then reissue talk requests to re-queue themselves.

Thus, by distributing state information to the user communications terminals, the server causes the user communications terminals to resolve the error condition of nonuse of communications channel resources.

Thus, as described above, in a push-to-talk communications system according to an embodiment of the present invention, the server distributes state information to the user communications terminals, and the user communications terminals execute a distributed arbitration algorithm that determines who should have possession of the communications channel. Executing the distributed arbitration algorithm at the user communications terminals rather than at the server frees server resources for distributing packet-based voice among the user communications terminals. In addition, the failure of the arbitration algorithm at a single user communications terminal will not result in a total system failure.

Additional error conditions that may occur are two user communications terminals claiming the floor and the wrong user communications terminal claiming the floor. For example, a user communications terminal may not have received a queue update notification from the server or may have developed a memory or processor fault, resulting in an erroneous determination that the particular user communications terminal has the floor instead of the user communications terminal that should have the floor.

In this circumstance, the first user communications terminal to claim the floor has already seized the floor using the procedure described above. Since the floor is already in use, the server must re-notify other user communications terminals claiming the floor of the ID of the speaker and give them the state of the queue. If a user communications terminal determines that the current speaker has seized the floor in error, the user communications terminal may remove itself from the queue and re-queue itself. Thus, the distributed arbitration scheme according to the present invention automatically resolves conflicts among user communications channels by granting the floor to the user communications channel to request the floor.

It will be understood that various details of the invention may be changed without departing from the scope of the invention. Furthermore, the foregoing description is for the purpose of illustration only, and not for the purpose of limitation—the invention being defined by the claims.

What is claimed is:

1. A method for distributed arbitration in a push-to-talk communications system, the method comprising:
(a) at a server, receiving talk requests from a plurality of user communications terminals in a push-to-talk communications system;
(b) generating state information based on the talk requests;
(c) distributing the state information to the user communications terminals; and
(d) at the user communications terminals, executing a distributed arbitration algorithm to determine which user communications terminal should have possession of a communications channel among user communications terminals with simultaneously pending talk requests based on the state information.

2. The method of claim 1 wherein each talk request includes an identifier identifying a user communications terminal that sent the request.

3. The method of claim 2 wherein each talk request includes a priority level indicating a relative talk priority for each user communications terminal.

4. The method of claim 1 wherein generating state information based on the talk requests includes generating a queue based on time of receipt of the talk requests and wherein executing a distributed arbitration algorithm at the user communications terminals includes, at each user communications terminal, determining whether the user communications terminal is at the head of the queue.

5. The method of claim 3 wherein distributing state information to the user communications terminals includes distributing a list of talk requests and corresponding priority levels to the user communications terminals and wherein executing a distributed arbitration algorithm at the user communications terminals includes determining which user communications terminal should have possession of the communications channel based on the priority levels.

6. The method of claim 3 wherein one or more priority levels are associated with a preemption privilege whereby each user communications terminal with such priority may preempt a user communications terminal with lower priority that currently has possession of the communications channel.

7. The method of claim 6 comprising at a first user communications terminal with preemption priority and requiring access to the communications channel:
(a) determining whether the first user communications terminal's priority is greater than the priority of the user communications terminal that currently has possession of the communications channel;
(b) in response to determining that the first user communications terminal's priority is greater than that of the user communications terminal that has possession of the communications channel, sending a preemption message to the server; and
(c) receiving a preemption confirmation message from the server, and, in response taking possession of the communications channel from the user communications terminal that currently has possession of the communications channel.

8. The method of claim 1 further comprising at a user communications terminal, in response to determining that the user communications terminal should have possession of the communications channel, sending a message to the server indicating that the user communications terminal has taken possession of the communications channel.

9. The method of claim 8 comprising, at the server, receiving the message from the user communications terminal indicating that the user communications terminal has taken possession of the communications channel, and broadcasting a message to the user communications terminals identifying the user communications terminal that has taken possession of the communications channel.

10. The method of claim 9 comprising, at a first user communications terminal having a talk request located at the head of a talk queue:
(a) receiving the message from the server identifying the user communications terminal that has taken possession of communications channel;
(b) determining that the user communications terminal that has taken possession of the communications channel has done so in error; and
(c) in response to determining that the user communications terminal that has taken possession of the talk queue has done so in error, re-queuing the talk request in the talk queue.

11. The method of claim 10 wherein re-queuing the talk request in the talk queue includes sending a first message to the server for removing the talk request from the talk queue and sending a second message to the server including a new talk request.

12. The method of claim 1 comprising receiving first and second messages at the server indicating that first and second user communications terminals are taking possession of the communications channel, acknowledging the first message, and broadcasting a message to the user communications terminals indicating that the first user communications terminal has taken possession of the communications channel.

13. The method of claim 12 comprising, at the second communications terminal, receiving the message from the server indicating that the first user communications terminal has taken possession of the communications channel, and, in response, re-queuing a talk request of the second communications terminal in a talk queue.

14. The method of claim 13 wherein re-queuing a talk request in the talk queue includes sending a third message to the server requesting removal of a pending talk request of the second communications terminal from the talk queue and sending a fourth message to the server including a new talk request.

15. The method of claim 9 further comprising, at the server, receiving an indication that the user communications terminal that has taken possession of the communications channel has relinquished possession of the communications channel, and wherein distributing state information to the user communications terminals includes notifying the user communications terminals that the user communications terminal has relinquished possession of the communications channel.

16. The method of claim 15 comprising at the user communications terminals, recalculating positions in a talk queue based on the notification from the server.

17. The method of claim 1 further comprising at the server, receiving notification that a user communications terminal has taken possession of the communications channel and determining whether a signal is present from the handset on the communications channel.

18. The method of claim 17 further comprising at the server, in response to failing to detect a signal from the user communications terminal on the communications channel within a predetermined time period, distributing state information to the user communications terminal to trigger the user communications terminals to re-evaluate possession of the communications channel.

19. The method of claim 1 further comprising at the server, detecting a non-empty talk queue.

20. The method of claim 19 further comprising at the server, in response to detecting a non-empty talk queue, determining whether a communications terminal in the talk queue takes possession of the communications channel within a predetermined time period.

21. The method of claim 20 further comprising at the server, in response to determining that a communications terminal fails to take possession of the communications channel within the predetermined time period, distributing state information to the communications terminals to trigger one of the communications channels to take possession of the communications channel.

22. The method of claim 1 wherein the user communications terminals include mobile handsets.

23. The method of claim 1 wherein the user communications terminals include general-purpose computers.

24. The method of claim 1 wherein the user communications terminals include mobile handsets and general-purpose computers.

25. A push-to-talk communications system comprising:
(a) a server for maintaining state information regarding a push-to-talk communications system and for distributing the state information to a plurality of mobile user communications terminals in the push-to-talk communications system; and.
(b) a plurality of user communications terminals for issuing talk requests to the server, for receiving the state information from the server, and for the executing a distributed arbitration algorithm for determining, based on the state information, which user communications terminal should have possession of the communications channel when the state information received from the server indicates that multiple talk requests from different user communications terminals are simultaneously pending.

26. The system of claim 25 wherein the user communications terminals are adapted to include a user communications terminal identifier in each talk request sent to the server.

27. The system of claim 26 wherein the user communications terminals are adapted to include a priority level in each talk request sent to the server.

28. The system of claim 26 wherein the server is adapted to send a list of user communications terminal identifiers for pending talk requests to the user communications terminals and the user communications terminals are adapted to determine which user communications terminal should have possession of the communications channel based on time of receipt of the requests at the server.

29. The system of claim 27 wherein the server is adapted to send a list of pending talk requests and corresponding priority levels to user communications terminals and the user communications terminals are adapted to determine which user communications terminal should have possession of the communications channel based on the priority levels.

30. The system of claim 27 wherein one or more priority levels are associated with a preemption privilege whereby each user communications terminal with such priority may preempt a user communications terminal with lower priority that currently has possession of the communications channel.

31. The system of claim 30 wherein each user communications terminal with preemptive priority and requesting access to the communications channel determines whether its priority is greater than that of the user communications terminal that currently has possession of the communications channel, and, in response to determining that the user communications terminal's priority is greater than that of the user communications terminal that currently has possession of the communications channel, the user communications terminal take possession of the communications channel from the user communications terminal that currently has possession of the communications channel.

32. The system of claim 25 wherein each user communications terminal is adapted to notify the server in response to determining that the user communications terminal has taken possession of the communications channel.

33. The system of claim 32 wherein the server is adapted to notify the user communications terminals of the ID of the user communications terminal that has taken possession of the communications channel.

34. The system of claim 25 wherein the server is adapted to determine whether a user communications terminal that has taken possession of the communications channel fails to use the communications channel within a predetermined time period, and, and response, the server is adapted to send state information to the user communications terminals for triggering the user communications terminals to reevaluate which user communications terminal should have possession of the communications channel.

35. The system of claim 25 wherein the server is adapted to detect when a user communications terminal fails to take possession of the communications channel within a predetermined time period when a talk queue is non-empty, and, in response, the server is adapted to distribute state information to the communications terminals in the talk queue to trigger re-evaluation of possession of the communications channel.

36. The system of claim 25 wherein the user communications terminals include mobile handsets.

37. The system of claim 25 wherein the user communications terminals include general-purpose computers.

38. The system of claim 25 wherein the user communications terminals include mobile handsets and general-purpose computers.
